(19) United States
(12) Patent Application Publication
(10) Pub. No.: US 2026/0132350 A1
(43) Pub. Date: May 14, 2026

(54) FLUID DYNAMIC BEARING, SPINDLE MOTOR, AND DISK DRIVE DEVICE

(71) Applicant: MINEBEA MITSUMI Inc., Nagano (JP)

(72) Inventors: Takuya KITAJIMA, Kitasaku-gun, Nagano (JP); Jun HATCHO, Kitasaku-gun, Nagano (JP); Yuto SASAKI, Kitasaku-gun, Nagano (JP)

(21) Appl. No.: 18/709,955

(22) PCT Filed: Nov. 18, 2022
(86) PCT No.: PCT/JP2022/042914

§ 371 Date: Jul. 16, 2024

(30) Foreign Application Priority Data
Nov. 19, 2021 (JP) 2021-188948

(51) Int. Cl. C10M 169/04; C10M 105/40; C10M 135/08; C10M 139/00; C10N 40/18; F16C 32/06

(52) U.S. Cl. CPC C10M 169/04; C10M 105/40; C10M 135/08; C10M 139/00; F16C 32/0633; C10M 2207/2835; C10M 2219/04; C10M 2227/062; C10N 2040/18; F16C 2380/00

(57) ABSTRACT

[Object] To provide a fluid dynamic bearing filled with a lubricating oil composition containing a base oil and an ionic liquid, and to provide a spindle motor in which evaporation is suppressed in the lubricating oil composition provided in the fluid dynamic bearing by incorporating the fluid dynamic bearing in the spindle motor, and thus occurrence of a read/write error in an HDD can be suppressed, and a disk drive device including the spindle motor. [Solution means] A fluid dynamic bearing filled with a lubricating oil composition containing a base oil and an ionic liquid, wherein the ionic liquid contains at least one cation selected from the group consisting of a tetraalkylphosphonium cation and a tetraalkylammonium cation and at least one anion selected from the group consisting of an imide anion, a methide anion, and borate anions represented by formulae (C-1) to (C-3). (In the formulae, R⁹ and R¹¹ each independently represent a linear or branched alkyl group, and R¹⁰ and R¹² each independently represent a hydrogen atom or a linear or branched alkyl group.)

### TECHNICAL FIELD

The present invention relates to a fluid dynamic bearing filled with a lubricating oil composition containing a base oil and an ionic liquid, and a spindle motor including the fluid dynamic bearing. Moreover, the present invention relates to a disk drive device including the spindle motor.

### BACKGROUND ART

Various lubricants such as grease and oil are used for pivot assemblies used in fulcrum portions of actuators of hard disk drives (HDDs) and bearings incorporated in spindle motors for smooth operation of these components and smooth driving of these devices.

An ionic liquid is a salt in a liquid state including only ions (anions, cations). The ionic liquids have characteristics such as low vapor pressure (nonvolatile), high thermal stability, flame retardancy, low viscosity, and high ionic conductivity, can design various physical properties by a combination of a cation and an anion, and thus are expected to be applied to various technical fields including electrolytic solutions and solvents.

From the characteristics including the low vapor pressure, the high thermal stability, and the low viscosity described above, application to the above-described lubricant has also been studied, and for example, there is a proposal of a lubricant composition to which an ionic liquid is added for the purpose of maintaining low friction property for a long time under a high load condition (Patent Literature 1).

### CITATION LIST

### Patent Literature

Patent Literature 1: JP 2019-065256 A

### SUMMARY OF INVENTION

### Technical Problem

One of the causes of occurrence of read/write errors in HDDs is volatilization and evaporation of a lubricant component filled in the bearing incorporated in the actuator or spindle motor. When the volatilized and evaporated lubricant component is cooled, condensed on the surface of a magnetic disk or a magnetic head, and adheres to the surface of the magnetic disk or the magnetic head as a liquid or a solid, the magnetic disk and the magnetic head are attracted to each other and normal reading and writing are not possible, which is considered to be a cause of read/write errors.

So far, no proposal has been made in consideration of evaporation of a lubricant, particularly a base oil contained in the lubricant, in a known lubricant to which an ionic liquid is added, including the lubricant composition described in Patent Literature 1.

An object of the present invention is to provide a fluid dynamic bearing filled with a lubricating oil composition containing a base oil and an ionic liquid, and to provide a spindle motor in which evaporation is suppressed in the lubricating oil composition provided in the fluid dynamic bearing by incorporating the fluid dynamic bearing in the spindle motor, and thus occurrence of a read/write error in an HDD can be suppressed, and a disk drive device including the spindle motor.

### Solution to Problem

One aspect of the present invention relates to a fluid dynamic bearing filled with a lubricating oil composition containing a base oil and an ionic liquid, wherein the ionic liquid is an ionic liquid containing:

at least one cation selected from the group consisting of a tetraalkylphosphonium cation represented by formula (A) below and a tetraalkylammonium cation represented by formula (B) below, and at least one anion selected from the group consisting of a bis(trifluoromethylsulfonyl)imide anion, a tris(trifluoromethylsulfonyl) methide anion, a borate anion represented by formula (C-1) below, a borate anion represented by formula (C-2) below, and a borate anion represented by formula (C-3) below:

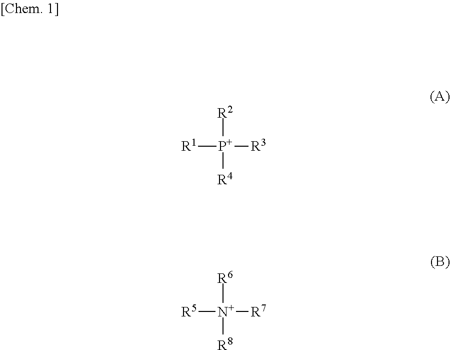

(in formula (A), R¹, R², R³, and R⁴ each independently represent a linear or branched alkyl group having from 1 to 18 carbons, and
in formula (B), R⁵, R⁶, R⁷, and R⁸ each independently represent a linear or branched alkyl group having from 1 to 18 carbons).

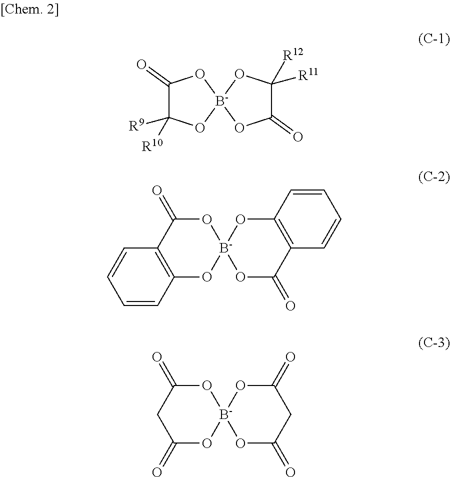

(in formula (C-1), R⁹ and R¹¹ each independently represent a linear or branched alkyl group having from 1 to 22 carbons, and R¹⁰ and R¹² each independently represent a hydrogen atom or a linear or branched alkyl group having from 1 to 22 carbons).

The present invention also relates to a spindle motor including the fluid dynamic bearing.

Moreover, the present invention relates to a disk drive device including the spindle motor.

### BRIEF DESCRIPTION OF DRAWINGS

FIG. 1 is a conceptual diagram illustrating an example of a main component structure of a spindle motor of the present invention.

FIG. 2 is a schematic view illustrating an example of a structure of a drive device (disk drive device) of the present invention.

### DESCRIPTION OF EMBODIMENTS

As described above, when a component contained in an evaporation component of a lubricant composition adheres to a recording disk or the like, it may lead to a read/write error, and thus it is desirable to suppress evaporation of the lubricant component as much as possible.

In particular, with an increase in capacity and density of recording information of an HDD and an increase in processing speed in recent years, a fly height (distance between a magnetic head and a magnetic disk) of a disk drive device has narrowed to about several nm, and there is an increasing concern about defects that may be caused by evaporation of the lubricant component and adhesion associated with the evaporation. Since the fly height is reduced, a space between the magnetic head and the disk can be brought into a negative pressure state, and in this case, the surrounding gas is compressed/condensed toward the space between the magnetic head and the disk, so that even a small amount of evaporative/volatile components may be liquefied, leading to adhesion to the disk and the like. In recent years, with an increase in the recording capacity per HDD, the number of disks in the device has increased, and disk drive devices having 9 or more 3.5-inch-diameter disks have been put on the market. In such a device, a spatial volume within the device is further reduced. In such an environment having a small spatial volume and a fly height on the order of several nanometers, even a very small amount of contamination may lead to read/write errors.

A disk drive device including an internal space filled with a gas (for example, helium or the like) having a lower density than air has also started to spread. In such a disk drive device, the air pressure inside the device may be less than one atmosphere. In this case, it is more difficult to suppress evaporation/volatilization of the lubricant component. In particular, in the case of an HDD employing a heat-assisted magnetic recording (HAMR) system which is a next-generation recording technology, the temperature of a head part of an actuator can locally reach a temperature as high as 400° C. As a result, since an internal temperature of the HDD rises, evaporation and volatilization of the lubricant component are more likely to occur than before, and there is an increasing possibility of causing a defect related to disk reading and writing.

A lubricating oil composition applied to the fluid dynamic bearing according to the present invention is characterized in that a specific ionic liquid is blended as described later. The blending of the lubricating oil composition can be expected to suppress the evaporation amount of the composition even in application to a disk drive device adopting a heat-assisted magnetic recording system, and can contribute to suppression of occurrence of a read/write error of the HDD due to the evaporation component.

Hereinafter, this will be described with details.

### [Fluid Dynamic Bearing]

First, a preferred embodiment of the fluid dynamic bearing according to the present invention will be described in detail below with reference to the accompanying drawings.

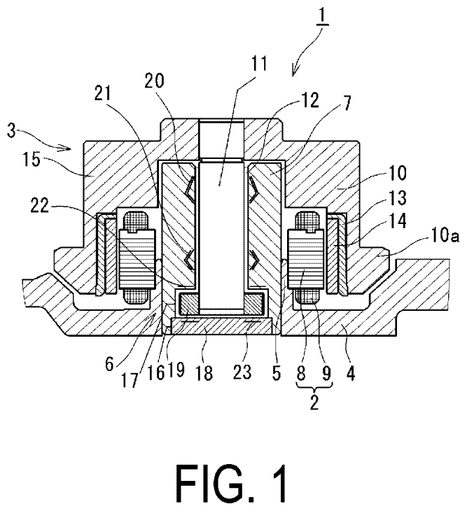

FIG. 1 is a schematic view for illustrating a fluid dynamic bearing and a spindle motor including the fluid dynamic bearing according to an embodiment of the present invention. Note that the embodiments described below are exemplary embodiments of the present invention, and the present invention is not limited to the embodiments.

As illustrated in FIG. 1, a spindle motor 1 is used as a motor for driving a data storage device including a magnetic disk, an optical disk, or the like used for a computer. As a whole, the spindle motor 1 includes a stator assembly 2 and a rotor assembly 3. Although the spindle motor 1 in FIG. 1 is a shaft rotating type motor, the present invention is also applicable to a shaft fixed type motor.

The stator assembly 2 is fixed to a cylindrical part 5 provided to a housing 4 (base plate) constituting a casing of the data storage device in such a manner that the cylindrical part 5 protrudes upward. A stator core 8 wound around with a stator coil 9 is fitted and attached to an outer circumferential part of the cylindrical part 5.

The rotor assembly 3 includes a rotor hub 10, and the rotor hub 10 is fixed to an upper end part of a shaft 11 and rotates together with the shaft 11. The shaft 11 is inserted into a sleeve 7 being a bearing member and is rotatably supported by the sleeve 7. The sleeve 7 is fitted and fixed inside the cylindrical part 5. A lower cylindrical part 10a of the rotor hub 10 rotates inside the housing 4, but a back yoke 13 is mounted on an inner circumferential surface of the lower cylindrical part 10a, and a rotor magnet 14 is further fitted and fixed inside the back yoke 13 and is magnetized to a plurality of poles of N and S poles.

When the stator coil 9 is energized, a magnetic field is formed by the stator core 8, and this magnetic field acts on the rotor magnet 14 disposed in the magnetic field to rotate the rotor assembly 3. On an outer circumferential surface of an intermediate cylindrical part 15 of the rotor hub 10 of the rotor assembly 3, a recording disk, such as a magnetic disk (not illustrated), constituting a storage part of the data storage device, is mounted, and is configured to be rotated or stopped by the operation of the spindle motor 1, so that information writing and data processing are performed by a recording head (not illustrated).

In the spindle motor 1 of such an embodiment, a fluid dynamic bearing 6 is provided at a portion where the sleeve 7 rotatably supports the shaft 11.

A large-diameter first recess 16 opening downward is provided at a lower end part of the sleeve 7, and a small-diameter second recess 17 is further formed at a top surface of the first recess 16. A counter plate (thrust receiving plate) 18 is fitted into the large-diameter first recess 16 and fixed to the first recess 16 by, for example, welding, bonding, or the other means, so that the inside of the sleeve 7 is in an airtight state.

A thrust washer 19 is fitted, press-fitted and fixed to a lower end part of the shaft 11, and the thrust washer 19 is disposed in the second recess 17 of the sleeve 7 to rotate together with the shaft 11 while opposing the counter plate 18 and a top surface of the second recess 17.

A gap between the sleeve 7 and the shaft 11, a gap between the thrust washer 19 and the second recess 17, and a gap between the thrust washer 19 and the shaft 11 and the counter plate 18 communicate with one another, and a lubricating oil composition 12 described later is filled in the communication gaps. The lubricating oil composition 12 is injected from between the sleeve 7 and the shaft 11.

A first radial dynamic pressure groove 20 and a second radial dynamic pressure groove 21 for generating dynamic pressure are formed at an inner circumferential surface of the sleeve 7 opposing the shaft 11 to be spaced apart from each other in an axial direction. Due to the rotation of the shaft 11, the radial dynamic pressure grooves 20 and 21 generate dynamic pressure causing the shaft 11 and the sleeve 7 to be in a non-contact state in a radial direction. A first thrust dynamic pressure groove 22 and a second thrust dynamic pressure groove 23 are formed at the top surface of the second recess 17 opposing an upper end surface of the thrust washer 19 and an upper end surface of the counter plate 18 opposing a lower end surface of the thrust washer 19, respectively. Due to the rotation of the shaft 11, the thrust dynamic pressure grooves 22 and 23 generate dynamic pressure for stably floating the shaft 11 in a thrust direction. Due to the operation of the dynamic pressure grooves, the shaft 11 can stably rotate at a high speed in the non-contact state with respect to the sleeve 7. As the dynamic pressure grooves, known patterns such as herringbone grooves and spiral grooves can be used.

### [Disk Drive Device]

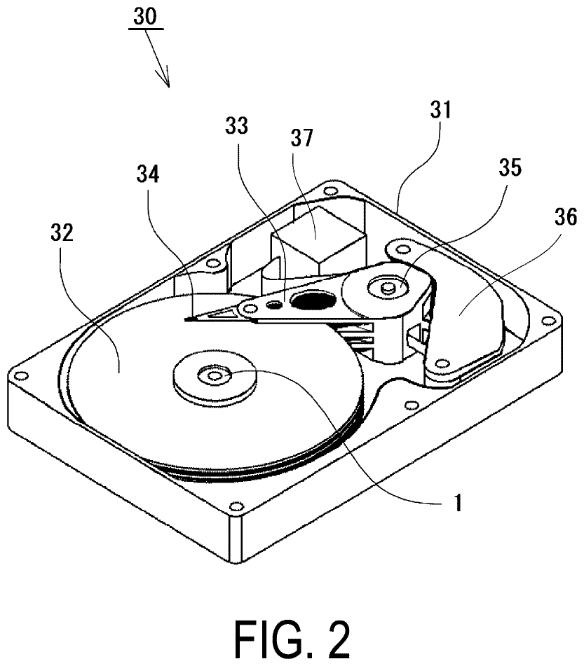

FIG. 2 is a perspective view illustrating an overall configuration of a disk drive device 30 with the spindle motor according to the present embodiment.

As illustrated in FIG. 2, the disk drive device 30 according to the present embodiment includes a base member (base plate) 31 having a substantially rectangular box shape, the spindle motor 1 placed on the base member 31, a magnetic disk 32 configured to be rotated by the spindle motor 1, a swing arm 33 having a magnetic head 34 for writing information at a predetermined position on the magnetic disk 32 and reading information from an arbitrary position on the magnetic disk 32, a pivot assembly bearing device 35 for swingably supporting the swing arm 33, an actuator 36 for driving the swing arm 33, and a control part 37 for controlling these components.

The disk drive device of the present invention can be a disk drive device including 9 or more 3.5-inch-diameter magnetic disks, for example. In such a device having a large number of disks, a spatial volume in the device is further reduced. The internal space of the disk drive device may be filled with a gas having a lower density than air. In such a disk drive device with its internal space filled with such a low-density gas, the air pressure inside the device may be less than one atmosphere. The disk drive device can employ a heat-assisted magnetic recording (HAMR) system as a recording system. In the disk drive device employing the heat-assisted magnetic recording (HAMR) system, the temperature of a head part of an actuator may locally reach a high temperature of 400° C.

The lubricating oil composition used in the present embodiment described later exhibits low evaporability. Thus, in the fluid dynamic bearing and the spindle motor using this, the evaporation of the components of the lubricating oil composition is suppressed even in driving at a high temperature, and it is possible to suppress a disk read/write error of the disk drive device due to the adhesion of the evaporation component to the magnetic disk or the like.

### [Lubricating Oil Composition]

The present inventors have focused on the addition of an ionic liquid in the lubricating oil composition applied to the fluid dynamic bearing. The present inventors have found that an ionic liquid including a specific cation and anion suppresses the evaporation amount of the lubricating oil composition, and also suppresses hydrolysis of an ester oil when the ester oil is used as the base oil.

Hereinafter, the lubricating oil composition filled in the fluid dynamic bearing of the present invention will be described.

### <Base Oil>

In the lubricating oil composition applied to the fluid dynamic bearing according to the present embodiment, the base oil is not particularly limited, and a synthetic oil such as a mineral oil, a hydrocarbon-based synthetic oil, an ester-based synthetic oil, or an ether-based synthetic oil, which is generally used as a base oil in a lubricating oil, can be used alone or in combination. Among these, the ester-based synthetic oil can be preferably used from the viewpoint of easily dissolving an ionic liquid described later.

Examples of the ester-based synthetic oil (also simply referred to as ester oil) include diester oil, monoester oil, polyol ester oil, and aromatic ester oil.

### <Diester Oil>

Examples of the diester oil include a diol ester oil produced from a diol and a monobasic acid or an acid mixture, and a dibasic acid diester oil produced from a dibasic acid and an alcohol.

### <<Diol Ester Oil>>

Specific examples of the diol ester oil include a diester represented by formula (1) below.

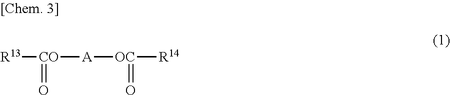

[where R¹³ and R¹⁴ are the same or different and each represent a linear alkyl group having from 3 to 17 carbons, and A represents a residue of a linear or branched aliphatic dihydric alcohol having from 2 to 10 carbons]

The diester represented by formula (1) is an ester compound prepared by fully esterifying a linear or branched aliphatic dihydric alcohol having from 2 to 10 carbons as an alcohol component and an aliphatic linear saturated monocarboxylic acid having from 4 to 18 carbons as an acid component according to a known method, preferably under an inert gas atmosphere such as nitrogen, in the presence or absence of an esterification catalyst under heating and stirring.

Specific examples of the linear or branched aliphatic dihydric alcohol having from 2 to 10 carbons as the alcohol component include ethylene glycol, 1,2-propanediol, 1,3-propanediol, 2-methyl-1,3-propanediol, 1,3-butanediol, 1,4-butanediol, 2-methyl-1,4-butanediol, 1,4-pentanediol, 1,5-pentanediol, 2-methyl-1,5-pentanediol, 3-methyl-1,5-pentanediol, 1,5-hexanediol, 1,6-hexanediol, 2-methyl-1,6-hexanediol, 3-methyl-1,6-hexanediol, 1,6-heptanediol, 1,7-heptanediol, 2-methyl-1,7-heptanediol, 3-methyl-1,7-heptanediol, 4-methyl-1,7-heptanediol, 1,7-octanediol, 1,8-octanediol, 2-methyl-1,8-octanediol, 3-methyl-1,8-octanediol, 4-methyl-1,8-octanediol, 1,8-nonanediol, 1,9-nonanediol, 2-methyl-1,9-nonanediol, 3-methyl-1,9-nonanediol, 4-methyl-1,9-nonanediol, 5-methyl-1,9-nonanediol, 1,10-decanediol, 2-ethyl-1,3-hexanediol, and 2,4-diethyl-1,5-pentanediol. Among them, from the viewpoint of excellent heat resistance and low-temperature fluidity, aliphatic dihydric alcohols having 1 to 2 branched chains and having from 4 to 6 carbons can be mentioned, and specific examples thereof include 2-methyl-1,3-propanediol, 1,3-butanediol, 2-methyl-1,4-butanediol, 1,4-pentanediol, 2-methyl-1,5-pentanediol, 3-methyl-1,5-pentanediol, 1,5-hexanediol, and particularly 3-methyl-1,5-pentanediol.

Specific examples of the aliphatic linear saturated monocarboxylic acid having from 4 to 18 carbons as the acid component include n-butanoic acid, n-pentanoic acid, n-hexanoic acid, n-heptanoic acid, n-octanoic acid, n-nonanoic acid, n-decanoic acid, n-undecanoic acid, n-dodecanoic acid, n-tridecanoic acid, n-tetradecanoic acid, n-pentadecanoic acid, n-hexadecanoic acid, n-heptadecanoic acid, and n-octadecanoic acid. Among them, aliphatic linear saturated monocarboxylic acids having from 4 to 12 carbons can be mentioned from the viewpoint of heat resistance and low viscosity at low temperature. Specifically, n-butanoic acid, n-pentanoic acid, n-hexanoic acid, n-heptanoic acid, n-octanoic acid, n-nonanoic acid, n-decanoic acid, n-undecanoic acid, and n-dodecanoic acid are mentioned, and in particular, n-heptanoic acid, n-octanoic acid, n-nonanoic acid, and n-decanoic acid can be mentioned.

The acid component can be subjected to esterification alone, or two or more kinds of acids can be mixed and used. When two or more kinds of acids are mixed and used for esterification, the resulting ester includes a mixed group ester containing a group derived from two or more kinds of acids in one molecule.

Preferred examples of the diol ester oil include diesters of 3-methyl-1,5-pentanediol and an aliphatic saturated linear monocarboxylic acid having from 7 to 11 carbons, and specific examples thereof include 3-methyl-1,5-pentanediol di(n-heptanoate), 3-methyl-1,5-pentanediol di(n-octanoate), 3-methyl-1,5-pentanediol di(n-nonanoate), 3-methyl-1,5-pentanediol di(n-decanoate), and 3-methyl-1,5-pentanediol di(n-undecanoate).

Preferable examples of the diol ester oil include a diester using 3-methyl-1,5-pentanediol and two kinds of aliphatic saturated linear monocarboxylic acids having from 7 to 11 carbons. Specific examples thereof include a diester of 3-methyl-1,5-pentanediol with n-heptanoic acid and n-octanoic acid, a diester of 3-methyl-1,5-pentanediol with n-heptanoic acid and n-nonanoic acid, a diester of 3-methyl-1,5-pentanediol with n-heptanoic acid and n-decanoic acid, a diester of 3-methyl-1,5-pentanediol with n-octanoic acid and n-nonanoic acid, a diester of 3-methyl-1,5-pentanediol with n-octanoic acid and n-decanoic acid, a diester of 3-methyl-1,5-pentanediol with n-nonanoic acid and n-decanoic acid, and a diester of 3-methyl-1,5-pentanediol with n-decanoic acid and n-decanoic acid.

### <<Dibasic Acid Diester Oil>>

Examples of the dibasic acid diester oil include full esters of aliphatic dibasic acids such as adipic acid, azelaic acid, and sebacic acid with an aliphatic saturated linear monohydric alcohol having from 4 to 16 carbons or an aliphatic saturated branched monohydric alcohol having from 4 to 16 carbons.

Specifically, di(n-butyl) adipate, di(n-octyl) adipate, di(n-nonyl) adipate, di(n-decyl) adipate, di(n-tridecyl) adipate, di(2-ethylhexyl) adipate, diisooctyl adipate, diisononyl adipate, di(3,5,5-trimethylhexyl) adipate, diisodecyl adipate, diisoundecyl adipate, diisododecyl adipate, diisotridecyl adipate, di(n-butyl) azelate, di(n-octyl) azelate, di(n-nonyl) azelate, di(n-decyl) azelate, di(n-tridecyl) azelate, di(2-ethylhexyl) azelate, diisooctyl azelate, diisononyl azelate, di(3,5,5-trimethylhexyl) azelate, diisodecyl azelate, diisoundecyl azelate, diisododecyl azelate, diisotridecyl azelate, di(n-butyl) sebacate, di(n-octyl) sebacate, di(n-nonyl) sebacate, di(n-decyl) sebacate, di(n-tridecyl) sebacate, di(2-ethylhexyl) sebacate, diisooctyl sebacate, diisononyl sebacate, di(3,5,5-trimethylhexyl) sebacate, diisodecyl sebacate, diisoundecyl sebacate, diisododecyl sebacate, and diisotridecyl sebacate.

### <Monoester Oil>

Examples of the monoester oil include full esters of an aliphatic linear monocarboxylic acid having from 6 to 18 carbons with an aliphatic saturated linear monohydric alcohol having from 8 to 24 carbons or an aliphatic saturated branched monohydric alcohol having from 8 to 24 carbons.

Specific examples thereof include n-octyl n-dodecanoate, n-nonyl n-dodecanoate, n-decyl n-dodecanoate, 2-ethylhexyl n-dodecanoate, isooctyl n-dodecanoate, isononyl n-dodecanoate, 3,5,5-trimethylhexyl n-dodecanoate, isodecyl n-dodecanoate, isoundecyl n-dodecanoate, isododecyl n-dodecanoate, isotridecyl n-dodecanoate, n-nonyl n-tetradecanoate, n-decyl n-tetradecanoate, 2-ethylhexyl n-tetradecanoate, isooctyl n-tetradecanoate, isononyl n-tetradecanoate, 3,5,5-trimethylhexyl n-tetradecanoate, isodecyl n-tetradecanoate, isoundecyl n-tetradecanoate, isododecyl n-tetradecanoate, isotridecyl n-tetradecanoate, n-nonyl n-hexadecanoate, n-decyl n-hexadecanoate, 2-ethylhexyl n-hexadecanoate, isooctyl n-hexadecanoate, isononyl n-hexadecanoate, 3,5,5-trimethylhexyl n-hexadecanoate, isodecyl n-hexadecanoate, isoundecyl n-hexadecanoate, isododecyl n-hexadecanoate, isotridecyl n-hexadecanoate, n-nonyl n-octadecanoate, n-decyl n-octadecanoate, 2-ethylhexyl n-octadecanoate, isooctyl n-octadecanoate, isononyl n-octadecanoate, 3,5,5-trimethylhexyl n-octadecanoate, isodecyl n-octadecanoate, isoundecyl n-octadecanoate, isododecyl n-octadecanoate, isotridecyl n-octadecanoate, and 2-decyltetradecyl 2-methylpentanoate.

### <Polyol Ester Oil>

Examples of the polyol ester oil include full esters of polyhydric alcohols [diols (for example, neopentyl glycol), triols (for example, trimethylolpropane), tetraols (for example, pentaerythritol), hexaols (for example, dipentaerythritol) and the like other than the compounds listed as specific examples of the above-described alcohol components] with linear and/or branched fatty acids having from 4 to 22 carbons.

Specific examples thereof include trimethylolpropane triheptanoate, trimethylolpropane tricaprylate, trimethylolpropane tripelargonate, pentaerythritol tetraheptanoate, pentaerythritol tri (2-ethylhexanoate), pentaerythritol tetraoleate, and neopentyl polyol.

### <Aromatic Ester Oil>

Examples of the aromatic ester oil include esters of aromatic polycarboxylic acids such as phthalic acid, trimellitic acid, and pyromellitic acid with aliphatic monoalcohols having from 4 to 16 carbons.

Specific examples thereof include ditridecyl phthalate, trioctyl trimellitate, tri-2-ethylhexyl trimellitate, tridecyl trimellitate, tetraoctyl pyromellitate, and tetra-2-ethylhexyl pyromellitate.

A ratio of the base oil to a total amount of the lubricating oil composition applied to the fluid dynamic bearing of the present invention can be a balance excluding a blending amount of the ionic liquid described later and a blending amount of other additives that can be blended as necessary.

### <Ionic Liquid>

The lubricating oil composition applied to the fluid dynamic bearing according to the present embodiment essentially contains a specific ionic liquid.

In the known art, in order to release static electricity generated between components due to rotational friction, conductivity is imparted to a lubricant as necessary, and addition of an ionic liquid is considered as one method thereof.

The ionic liquid used in the present invention plays a role of suppressing the evaporation amount of the lubricating oil composition and hydrolysis of ester oil used as a base oil in addition to imparting conductivity.

The ionic liquid includes at least one cation selected from the group consisting of a tetraalkylphosphonium cation represented by formula (A) below and a tetraalkylammonium cation represented by formula (B) below, and at least one anion selected from the group consisting of a bis(trifluoromethylsulfonyl)imide anion, a tris(trifluoromethylsulfonyl) methide anion, a borate anion represented by formula (C-1) below, a borate anion represented by formula (C-2) below, and a borate anion represented by formula (C-3) below.

### <Cation>

The tetraalkylphosphonium cation used in the ionic liquid according to the present invention is represented by formula (A).

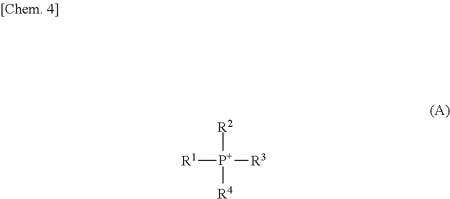

In formula (A), R¹, R², R³, and R⁴ each independently represent a linear or branched alkyl group having from 1 to 18 carbons.

Preferably, R¹, R², R³, and R⁴ each independently represent a linear or branched alkyl group having from 4 to 18 carbons.

Examples of the alkyl group having from 1 to 18 carbons in formula (A) include a methyl group, an ethyl group, a n-propyl group, a n-butyl group, a sec-butyl group, a tert-butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, and an octadecyl group.

Examples of the combination of R¹, R², R³, and R⁴ in formula (A) include a combination in which R¹ is a linear or branched alkyl group having from 11 to 18 carbons and R² to R⁴ are each independently a linear or branched alkyl group having from 4 to 10 carbons, a combination in which R¹ is a linear or branched alkyl group having from 12 to 16 carbons and R² to R⁴ are each independently a linear or branched alkyl group having from 4 to 8 carbons, and a combination in which R¹ to R⁴ are each independently a linear or branched alkyl group having from 6 to 12 carbons.

The total number of carbons of R¹, R², R³, and R⁴ in formula (A) may be, for example, 32.

Examples of the tetraalkylphosphonium cation represented by formula (A) include a (tetradecyl)tri (hexyl)phosphonium cation in which R¹ is a tetradecyl group and R² to R⁴ are hexyl groups, and a tetraoctylphosphonium cation in which R¹ to R⁴ are octyl groups.

The tetraalkylammonium cation is represented by formula (B).

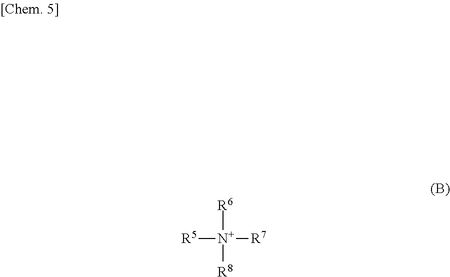

In formula (B), R⁵, R⁶, R⁷, and R⁸ each independently represent a linear or branched alkyl group having from 1 to 18 carbons.

Preferably, R⁵, R⁶, R⁷, and R⁸ each independently represent a linear or branched alkyl group having from 5 to 18 carbons.

Examples of the alkyl group having from 1 to 18 carbons in formula (B) include a methyl group, an ethyl group, a n-propyl group, a n-butyl group, a sec-butyl group, a tert-butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, and an octadecyl group.

Examples of the combination of R⁵, R⁶, R⁷, and R⁸ in formula (B) include a combination in which R⁵ is a linear or branched alkyl group having from 1 to 4 carbons and R⁶ to R⁸ are each independently a linear or branched alkyl group having from 6 to 14 carbons, a combination in which R⁵ is a linear or branched alkyl group having from 11 to 16 carbons and R⁶ to R⁸ are each independently a linear or branched alkyl group having from 6 to 10 carbons, and a combination in which R⁵ to R⁸ are each independently a linear or branched alkyl group having from 6 to 12 carbons.

The total number of carbons of R⁵, R⁶, R⁷, and R⁸ in formula (B) may be, for example, 24 to 40.

Examples of the tetraalkylammonium cation represented by formula (B) include a tetrahexylammonium cation in which R⁵ to R⁸ are hexyl groups, a methyltri (octyl) ammonium cation in which R⁵ is a methyl group and R⁶ to R⁸ are octyl groups, a (tetradecyl)tri (hexyl) ammonium cation in which R⁵ is a tetradecyl group and R⁶ to R⁸ are hexyl groups, a tetraoctylammonium cation in which R⁵ to R⁸ are octyl groups, and a tetradecylammonium cation in which R⁵ to R⁸ are decyl groups.

### <Anion>

The anion used in the ionic liquid according to the present invention is selected from the group consisting of a bis(trifluoromethylsulfonyl)imide anion, a tris(trifluoromethylsulfonyl) methide anion, a borate anion represented by formula (C-1), a borate anion represented by formula (C-2), and a borate anion represented by formula (C-3).

From the viewpoint that regulations such as prohibition and restriction of use of fluorine-based compounds have been advanced in recent years, it is desirable to use a borate anion represented by formula (C-1), a borate anion represented by formula (C-2), and a borate anion represented by formula (C-3) as the anion.

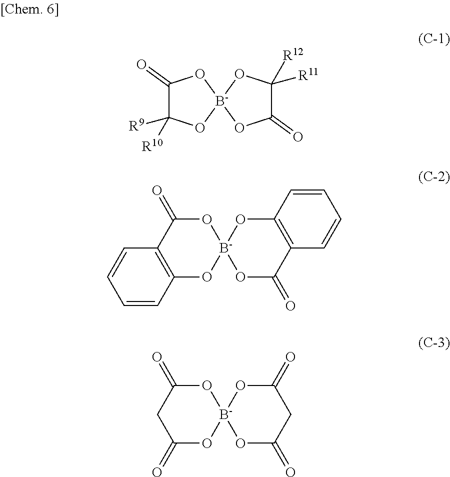

In formula (C-1), R⁹ and R¹¹ each independently represent a linear or branched alkyl group having from 1 to 22 carbons, and R¹⁰ and R¹² each independently represent a hydrogen atom or a linear or branched alkyl group having from 1 to 22 carbons.

In one aspect, R⁹, R¹⁰, R¹¹, and R¹² in formula (C-1) each independently represent a linear or branched alkyl group having from 1 to 22 carbons, a linear or branched alkyl group having from 1 to 6 carbons, or a linear or branched alkyl group having 1 or 2 carbons.

Examples of the alkyl group having from 1 to 22 carbons in R⁹, R¹⁰, R¹¹, and R¹² include a methyl group, an ethyl group, a n-propyl group, an isopropyl group, a n-butyl group, a sec-butyl group, a tert-butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, an eicosyl group, a heneicosyl group, and a docosyl group.

Examples of the combination of R⁹, R¹⁰, R¹¹, and R¹² in formula (C-1) include a combination in which R⁹ to R¹² are each independently a linear or branched alkyl group having from 1 to 6 carbons, a combination in which all of R⁹ to R¹² are methyl groups, and a combination in which R⁹ and R¹¹ are each independently a linear or branched alkyl group having from 1 to 6 carbons and R¹⁰ and R¹² are hydrogen atoms.

As the ionic liquid used in the present invention, for example, combinations of cations and anions shown in the following (a) to (j) can be used.

(a)

A combination of at least one cation selected from the group consisting of tetraalkylammonium cations and represented by formula (B), where R⁵, R⁶, R⁷, and R⁸ each independently represent a linear or branched alkyl group having from 5 to 18 carbons, with at least one anion selected from the group consisting of a borate anion represented by formula (C-1), a borate anion represented by formula (C-2), and a borate anion represented by formula (C-3).

(b)

A combination of at least one cation selected from the group consisting of tetraalkylammonium cations and represented by formula (B), where R⁵, R⁶, R⁷, and R⁸ each independently represent a linear or branched alkyl group having from 5 to 18 carbons, with at least one anion selected from the group consisting of a borate anion represented by formula (C-1) and a borate anion represented by formula (C-3).

(c)

A combination of at least one cation selected from the group consisting of tetraalkylammonium cations and represented by formula (B), where a total number of carbons of R⁵, R⁶, R⁷, and R⁸ is 24 to 40, with at least one anion selected from the group consisting of a borate anion represented by formula (C-1), where R⁹, R¹⁰, R¹¹ and R¹² are methyl groups and a borate anion represented by formula (C-3).

(d)

A combination of a tetraoctylammonium cation and a borate anion represented by formula (C-1) where R⁹, R¹⁰, R¹¹, and R¹² are methyl groups.

(e)

A combination of a (tetradecyl)tri (hexyl) ammonium cation and a borate anion represented by formula (C-1) where R⁹, R¹⁰, R¹¹, and R¹² are methyl groups.

(f)

A combination of a tetrahexylammonium cation and a borate anion represented by formula (C-1) where R⁹, R¹⁰, R¹¹, and R¹² are methyl groups.

(g)

A combination of a tetradecylammonium cation and a borate anion represented by formula (C-1) where R⁹, R¹⁰, R¹¹, and R¹² are methyl groups.

(h)

A combination of a tetradecylammonium cation and a borate anion represented by formula (C-3).

(i)

A combination of a tetrahexylammonium cation and a borate anion represented by formula (C-1) where R⁹ and R¹¹ are methyl groups and R¹⁰ and R¹² are ethyl groups.

(j)

A combination of a tetrahexylammonium cation and a borate anion represented by formula (C-1) where R⁹, R¹⁰, R¹¹, and R¹² are ethyl groups.

Among them, the ionic liquid including a combination of a cation and an anion shown in (d) to (j) can be expected to obtain the effect of suppressing the evaporation amount, suppressing the hydrolysis of the base oil, and improving the conductivity in the lubricating oil composition containing the ionic liquid.

The blending amount of the ionic liquid in the lubricating oil composition is not particularly limited, and can be appropriately selected according to the purpose.

For example, the content may be 0.01 mass % or more and 10 mass % or less, 0.03 mass % or more and 1 mass % or less, or 0.03 mass % or more and 0.5 mass % or less with respect to the base oil.

### <Additives>

Furthermore, in addition to the essential components described above, the lubricating oil composition can contain an additive normally used in lubricating oil compositions as necessary within a range not impairing the effects of the present invention.

Examples of the additive include extreme pressure additives, antioxidants, metal cleaners, oiliness agents, anti-wear agents, metal deactivators, corrosion inhibitors, rust inhibitors, viscosity index improvers, pour point depressants, conductivity imparting agents, dispersants, anti-foaming agents, and hydrolysis inhibitors.

When these additives are blended, the blending amount thereof can be, for example, 0.5 mass % to 5 mass %, or 1 mass % to 3 mass % with respect to the lubricating oil composition as the total amount of the additives.

Specific examples of the additives include, but are not limited to, the following.

Well-known additives containing sulfur, chloride, phosphorus, and the like can be used as the extreme pressure agents, and examples thereof include: phosphorus compounds such as phosphate esters, phosphite esters, and phosphate ester amine salts; sulfur compounds such as sulfides and disulfides; chlorine compounds such as chlorinated paraffin and chlorinated diphenyl; and metal salts of sulfur compounds such as zinc dialkyldithiophosphate and molybdenum dialkyldithiocarbamate.

Examples of the antioxidant include phenolic antioxidants, diphenylamines, phosphorus-based antioxidants, and sulfur compounds such as phenothiazine. These antioxidants may be used alone or in combination of two or more.

Examples of the anti-wear agent include phosphates, phosphites, and acid phosphates.

Examples of the rust inhibitor include dodecenyl succinic acid half ester.

Examples of the metal deactivator include benzotriazole-based compounds and thiadiazole-based compounds.

Examples of the viscosity index improver include polyalkyl methacrylates, polyalkyl styrenes, and polybutene.

Examples of the pour point depressant include the aforementioned viscosity index improvers such as polyalkyl methacrylates, polyalkyl styrenes, and polybutene.

Examples of the conductivity-imparting agent include nonionic surfactants, ionic liquids, and phenyl sulfonic acid.

Examples of the dispersant include polyalkenyl succinimides, polyalkenyl succinamides, polyalkenyl benzylamines, and polyalkenyl succinate esters.

Examples of the hydrolysis inhibitor include alkyl glycidyl ether type epoxy compounds, glycidyl ester type epoxy compounds, alicyclic epoxy compounds, and carbodiimides.

The present invention is not limited to the embodiment and specific examples described in the present specification, and various changes and variations can be made within the scope of the technical idea described in the claims.

### EXAMPLES

The present invention is described below in more detail with reference to examples. However, the present invention is not limited to the examples.

Using the ionic liquid of each of Examples 1 to 13 having cations and anions shown in Table 1, an evaporation amount test, a hydrolysis test, and a conductivity test were performed according to the procedure described later. As a comparative example, the above test was performed using only the base oil without using the ionic liquid. In the following description, the example number of the ionic liquid is also treated as the example number of the evaluation of each test.

TABLE 1
[Table 1] Ionic liquid

| | Cation | Anion |
|---|---|---|
| Example | Methyl tri(octyl)ammonium cation | Bis(trifluoromethylsulfonyl)imide anion |
| 1 | | |
| Example | (Tetradecyl)tri(hexyl)phosphonium | Bis(trifluoromethylsulfonyl)imide anion |
| 2 | cation | |
| Example | (Tetradecyl)tri(hexyl)phosphonium | Tris(trifluoromethylsulfonyl)methide anion |
| 3 | cation | |
| Example | Tetraoctylammonium cation | Borate anion represented by formula (C-1-1) |
| 4 | | below |
| Example | (Tetradecyl)tri(hexyl) ammonium | Borate anion represented by formula (C-1-1) |
| 5 | cation | below |
| Example | Tetrahexylammonium cation | Borate anion represented by formula (C-1-1) |
| 6 | | below |
| Example | Tetradecylammonium cation | Borate anion represented by formula (C-1-1) |
| 7 | | below |
| Example | Tetraoctylammonium cation | Borate anion represented by formula (C-2) |
| 8 | | below |
| Example | Tetradecylammonium cation | Borate anion represented by formula (C-3) |
| 9 | | below |
| Example | Tetrahexylammonium cation | Borate anion represented by formula (C-1-2) |
| 10 | | below |
| Example | Tetrahexylammonium cation | A borate anion represented by formula |
| 11 | | (C-1-3) below |
| Example | Tetrahexylammonium cation | Borate anion represented by formula (C-1-4) |
| 12 | | below |
| Example | Tetrahexylammonium cation | Borate anion represented by formula (C-1-5) |
| 13 | | below |

[Chem. 7]

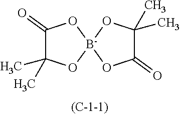

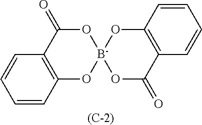

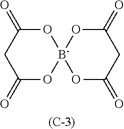 [SMILES: O=C1CC(=O)O[B-]2(O1)OC(=O)CC(=O)O2 ; "(C-3)"]

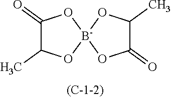

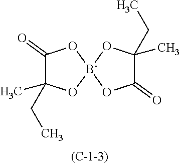

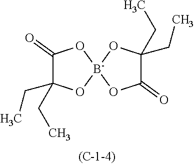 [SMILES: CCC1(CC)O[B-]2(OC1=O)OC(=O)C(CC)(CC)O2]

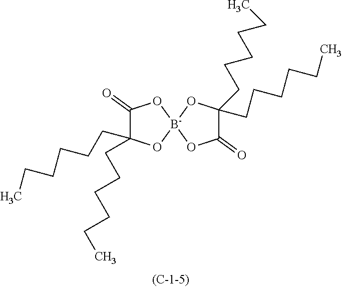 [SMILES: CCCCCCC1(CCCCCC)O[B-]2(OC1=O)OC(=O)C(CCCCCC)(CCCCCC)O2]

### (1) Evaporation Amount Test

A lubricating oil composition (evaporation amount test sample) was prepared by adding the ionic liquid of each Example to a base oil (diester (DE): 3-methyl-1,5-pentanediol di(n-undecanoate), CAS No. 1265799-70-9) so as to have a concentration of 500 ppm. The test sample was left standing in an oven maintained at 140° C. for 2000 hours under atmospheric pressure at a humidity of about 40 to 60% RH. The mass of the sample before and after the test (standing) was measured, and an amount of reduction in mass after standing was calculated.

When the mass reduction amount measured in Comparative Example 1 (containing no ionic liquid) was 100, a relative value of the mass reduction amount of each test sample was calculated. The results obtained are listed in Table 2 below.

### (2) Hydrolysis Test

Since an amount of the ester oil hydrolyzed is very small under a normal temperature and normal humidity environment, a highly accelerated life test (HAST test: Highly Accelerated Stress Test) was performed according to JIS C60068-2-66, “Environmental testing-Part 2: Test methods-Test Cx: Damp heat, steady state (unsaturated pressurized vapor)”.

A lubricating oil composition (hydrolysis test sample) was prepared by adding the ionic liquid of each Example to a base oil (diester (DE): 3-methyl-1,5-pentanediol di(n-undecanoate), CAS No. 1265799-70-9) so as to have a concentration of 500 ppm. The accelerated life test was performed by leaving the test sample in an oven maintained at 120° C. for 250 hours under a humidity of about 90% RH and 2 atmospheres. The mass of the sample before and after the test (standing) was measured, and the amount of reduction in mass after standing was calculated.

Ester as the base oil is hydrolyzed into an acid and an alcohol by heat and moisture (humidity). Since an acid and an alcohol generated by hydrolysis are more likely to evaporate than an ester as a hydrolysis source, either or both of the acid and the alcohol evaporate more preferentially than the ester.

In this accelerated life test, the sample in which hydrolysis has occurred has a more remarkable reduction in mass than the sample in which no hydrolysis has occurred, and the larger the mass reduction amount, the more the hydrolysis proceeds. The accelerated test was performed on the premise that most of the mass reduction of the sample was caused by hydrolysis.
(1) Similarly to the evaporation amount test, when a weight reduction amount measured in Comparative Example 1 (containing no ionic liquid) was 100, a relative value of the weight reduction amount of each test sample was calculated. Based on the obtained results, evaluation was performed according to the following criteria for determination. The obtained results are shown in Table 2 together with the relative value of the weight reduction amount.

### <Evaluation Criteria>

E (Excellent): The relative value of the weight reduction amount is less than 95.
A (Acceptable): The relative value of the weight reduction amount is 95 or more.

The upper limit of the relative value that can be evaluated as A (Acceptable) is generally about 110.

### (3) Conductivity Test

As a lubricating oil composition (conductivity test sample 1), an ionic liquid of each Example was added to a base oil of a monoester (ME) (2-methylpentanoic acid 2-decyltetradecyl ester represented by the following formula: Pentanoic acid, 2-methyl-, 2-decyltetradecyl ester) so as to have a concentration of 1000 ppm to prepare a sample.

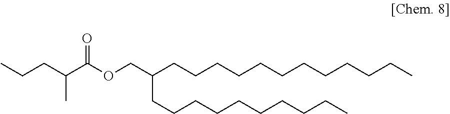 [SMILES: CCCCCCCCCCCCC(CCCCCCCCCC)COC(=O)C(C)CCC]

In addition, as a lubricating oil composition (conductivity test sample 2), the ionic liquid of each Example was added to a base oil of diester (DE) (3-methyl-1,5-pentanediol di(n-undecanoate), CAS No. 1265799-70-9) so as to have a concentration of 500 ppm to prepare a sample.

The conductivities [pS/cm] of the prepared conductivity test sample 1 and conductivity test sample 2 were measured by HIGH RESISTANCE METER (4339A) manufactured by Hewlett-Packard Company under the conditions of 20 to 30° C., a humidity of 40 to 60% RH, and atmospheric pressure. Based on the obtained results, evaluation was performed according to the following criteria for determination. The obtained results are shown in Table 2 together with the measurement results of the conductivity.

### <Evaluation Criteria>

[Case where Monoester (ME) is Used as Base Oil]
E (Excellent): 90 pS/cm or more
G (Good): 70 pS/cm or more and less than 90 pS/cm
P (Poor): less than 70 pS/cm
   [Case where Diester (DE) is Used as Base Oil]
E (Excellent): 500 pS/cm or more
G (Good): 200 pS/cm or more and less than 500 pS/cm
P (Poor): less than 200 pS/cm

TABLE 2

| Evaluation | Base | | Examples | | | | | |
|---|---|---|---|---|---|---|---|---|
| items | oil*¹ | | 1 | 2 | 3 | 4 | 5 | 6 |
| Evaporation | DE | Measurement result | 95.3 | 94.2 | 97.0 | 96.2 | 95.4 | 94.6 |
| amount | | (relative value) *² | | | | | | |
| characteristics | | | | | | | | |
| Hydrolysis | DE | Measurement result | 108.5 | 102.3 | 98.3 | 83.0 | 89.4 | 90.4 |
| characteristics | | (relative value) *² | | | | | | |
| | | Evaluation*³ | A | A | A | E | E | E |
| Conductivity | ME | Measurement result | 91.7 | >250 | >250 | 197.2 | 218.0 | 212.2 |
| | | [pS/cm] | | | | | | |
| | | Evaluation*⁴ | E | E | E | E | E | E |
| | DE | Measurement result | >1100 | >1100 | >1100 | 718.2 | 714.9 | 1006.6 |
| | | [pS/cm] | | | | | | |
| | | Evaluation *⁵ | E | E | E | E | E | E |

| | | | | | | | | Comparative |
|---|---|---|---|---|---|---|---|---|
| Evaluation | Examples | | | | | | | Example |
| items | 7 | 8 | 9 | 10 | 11 | 12 | 13 | 1 |
| Evaporation | 92.7 | 94.5 | 95.2 | 99.8 | 92.5 | 93.2 | 93.5 | 100 |
| amount | | | | | | | | |
| characteristics | | | | | | | | |
| Hydrolysis | 91.7 | 83.4 | 92.7 | 107.4 | 92.1 | 90.2 | 96.5 | 100 |
| characteristics | | | | | | | | |
| | E | E | E | A | E | E | A | — |
| Conductivity | 163.9 | 71.8 | 114.2 | 205.9 | 203.5 | 197.2 | 103.7 | 0.1 |
| | E | G | E | E | E | E | E | P |
| | 609.3 | 274.1 | 1064.6 | >1100 | 1089.1 | 1053.2 | 411.2 | 3.4 |
| | E | G | E | E | E | E | G | P |

*¹Base oil ME (monoester): 2-methylpentanoic acid (2-decyl)tetradecyl DE (diester): 3-methyl-1,5-pentanediol di(n-undecanoate)
*² Measurement results Relative value when Comparative Example 1 is taken as 100
*³Evaluation (hydrolysis characteristics: DE) E (Excellent): less than 95 A (Acceptable): 95 or more
*⁴Evaluation (conductivity: ME) E (Excellent): 90 pS/cm or more G (Good): 70 pS/cm or more and less than 90 pS/cm P (Poor): less than 70 pS/cm
*⁵ Evaluation (conductivity: DE) E (Excellent): 500 pS/cm or more G (Good): 200 pS/cm or more and less than 500 Ps/cm P (Poor): less than 200 pS/cm

As shown in Table 2, the lubricating oil composition using the ionic liquid of each of Examples 1 to 13 had excellent evaporation amount characteristics. In Examples 4 to 9 and 11 to 13, the hydrolysis characteristics were evaluated as E. With respect to the conductivity, all of Examples 1 to 13 were generally good, and in particular, Examples 1 to 7 and 9 to 12 resulted in excellent conductivity. Among these Examples, in Examples 4 to 79, 11, and 12, anions with less concern about use restriction and the like were used, and all of the evaporation amount characteristics, the hydrolysis characteristics, and the conductivity were excellent.

The best embodiments have been described in detail above, but the present invention is not limited to the embodiments described above, and variations, modifications, and the like within a range in which the object of the present invention can be achieved are included in the present invention.

### REFERENCE SIGNS LIST

1: Spindle Motor; 2: Stator Assembly; 3: Rotor Assembly; 4: Housing; 5: Cylindrical Part; 6: Fluid Dynamic Bearing; 7: Sleeve; 8: Stator Core; 9: Stator Coil; 10: Rotor Hub; 10a: Lower Cylindrical Part; 11: Shaft; 12: Lubricating Oil Composition; 13: Back Yoke; 14: Rotor Magnet; 15: Intermediate Cylindrical Part; 16: First Recess; 17: Second Recess; 18: Counter Plate; 19: Thrust Washer; 20: First Radial Dynamic Pressure Groove; 21: Second Radial Dynamic Pressure Groove; 22: First Thrust Dynamic Pressure Groove; 23: Second Thrust Dynamic Pressure Groove; 30: Disk Drive Device; 31: Base Member (Base Plate); 32: Magnetic Disk; 33: Swing Arm; 34: Magnetic Head; 35: Pivot Assembly Bearing Device; 36: Actuator; 37: Control Part

1. A fluid dynamic bearing filled with a lubricating oil composition, the composition containing a base oil and an ionic liquid, wherein the ionic liquid is an ionic liquid containing:
at least one cation selected from the group consisting of a tetraalkylphosphonium cation represented by formula (A) below and a tetraalkylammonium cation represented by formula (B) below, and
at least one anion selected from the group consisting of a bis(trifluoromethylsulfonyl)imide anion, a tris(trifluoromethylsulfonyl) methide anion, a borate anion represented by formula (C-1) below, a borate anion represented by formula (C-2) below, and a borate anion represented by formula (C-3) below: 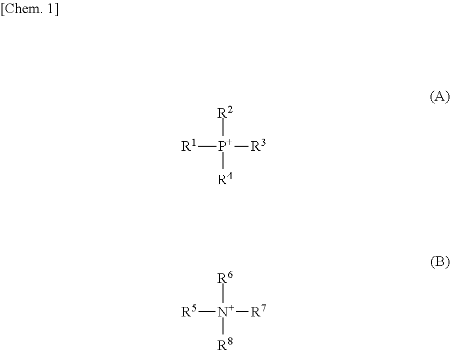
(in formula (A), R¹, R², R³, and R⁴ each independently represent a linear or branched alkyl group having from 1 to 18 carbons, and
in formula (B), R⁵, R⁶, R⁷, and R⁸ each independently represent a linear or branched alkyl group having from 1 to 18 carbons) 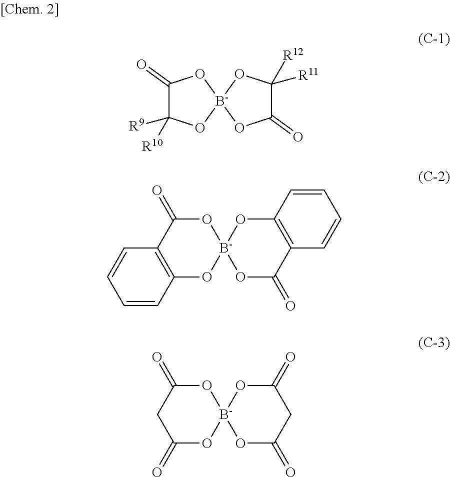
(in formula (C-1), R⁹ and R¹¹ each independently represent a linear or branched alkyl group having from 1 to 22 carbons, and R¹⁰ and R¹² each independently represent a hydrogen atom or a linear or branched alkyl group having from 1 to 22 carbons).

2. The fluid dynamic bearing according to claim 1, wherein the ionic liquid is an ionic liquid containing at least one anion selected from the group consisting of a borate anion represented by formula (C-1), a borate anion represented by formula (C-2), and a borate anion represented by formula (C-3).

3. The fluid dynamic bearing according to claim 2, wherein the ionic liquid is an ionic liquid containing at least one anion selected from the group consisting of a borate anion represented by formula (C-1) and a borate anion represented by formula (C-3).

4. The fluid dynamic bearing according to claim 3, wherein the ionic liquid is an ionic liquid containing a borate anion represented by formula (C-1), and, in formula (C-1), R⁹, R¹⁰, R¹¹, and R¹² each independently represent a linear or branched alkyl group having from 1 to 22 carbons.

5. The fluid dynamic bearing according to claim 4, wherein the ionic liquid is an ionic liquid containing a borate anion represented by formula (C-1), and, in formula (C-1), R⁹, R¹⁰, R¹¹, and R¹² each independently represent a linear or branched alkyl group having from 1 to 6 carbons.

6. The fluid dynamic bearing according to claim 5, wherein the ionic liquid is an ionic liquid containing a borate anion represented by formula (C-1), and, in formula (C-1), R⁹, R¹⁰, R¹¹, and R¹² each independently represent a linear or branched alkyl group having 1 or 2 carbons.

7. The fluid dynamic bearing according to claim 6, wherein the ionic liquid is an ionic liquid containing a tetraalkylammonium cation represented by formula (B), and, in formula (B), R⁵, R⁶, R⁷, and R⁸ each independently represent a linear or branched alkyl group having from 5 to 18 carbons.

8. The fluid dynamic bearing according to claim 2, wherein the base oil is an ester oil.

9. The fluid dynamic bearing according to claim 8, wherein the base oil is a monoester oil.

10. The fluid dynamic bearing according to claim 8, wherein the base oil is a diester oil.

11. The fluid dynamic bearing according to claim 10, wherein the base oil is a diol ester oil.

12. A spindle motor comprising the fluid dynamic bearing described in claim 1.

13. A disk drive device comprising the spindle motor described in claim 12.

14. The disk drive device according to claim 13, further comprising 9 or more 3.5-inch-diameter disks.

15. The disk drive device according to claim 13, having an internal space filled with a gas having a lower density than air.

16. The disk drive device according to claim 13, wherein the disk drive device employs a thermally assisted magnetic recording system.
